(19) United States
(12) Patent Application Publication
(10) Pub. No.: US 2016/0036715 A1
(43) Pub. Date: Feb. 4, 2016

(54) WIRELESS COMMUNICATION DEVICE, WIRELESS COMMUNICATION SYSTEM, AND COMMUNICATION CONTROL METHOD

(71) Applicant: FUJITSU LIMITED, Kawasaki-shi (JP)

(72) Inventors: Kimihisa Akazawa, Fukuoka (JP); Syuichi Haraguchi, Fukuoka (JP); Kazuhiro Kondo, Fukuoka (JP); Kouichi Kawarabata, Fukuoka (JP)

(21) Appl. No.: 14/797,908

(22) Filed: Jul. 13, 2015

(30) Foreign Application Priority Data
Aug. 1, 2014 (JP) 2014-157399

(51) Int. Cl. H04L 12/811; H04W 28/06

(52) U.S. Cl. CPC H04L 47/38; H04W 28/06

(57) ABSTRACT

A wireless communication device including: a memory, and a processor coupled to the memory and configured to: wirelessly receive a packet including a header that is compressed by another wireless communication device, decompress the compressed header based on a set compression mode among a plurality of compression modes, each of the plurality of compression modes having a different amount of feedback information transmitted from the wireless communication device to the another wireless communication device, obtain a quality of a wireless channel from the another wireless communication device to the wireless communication device, and select the set compression mode based on the obtained quality of the wireless channel.

### CROSS-REFERENCE TO RELATED APPLICATION

This application is based upon and claims the benefit of priority from the prior Japanese Patent Application No. 2014-157399 filed on Aug. 1, 2014, the entire contents of which are incorporated herein by reference.

### FIELD

The embodiments discussed herein are related to a wireless communication device, a wireless communication system, and a communication control method.

### BACKGROUND

A header compression method in communication using an internet protocol (IP) mainly via a wire has been proposed in related art with an objective of improving communication efficiency and reducing an error rate. In communication to which the header compression method is applied, a compressing unit of a communicating device on a transmitting side compresses the header of a packet, and transmits the packet including the compressed header. Then, a decompressing unit of a communicating device on a receiving side decompresses the received packet. Robust header compression (ROHC), for example, has been standardized as a standard for the header compression method. The header compression method uses redundancy in a field of the header. That is, for example, the value of an IP address field is usually fixed in packets of a same stream. Hence, the static field information (that is, a parameter scarcely varying in packet units) is transmitted by using an initial packet, and the transmission of the static field information can be omitted in subsequent packets. Relevant information in header fields may be referred to as a “context.” Incidentally, the above-described “decompression” refers to restoring the packet including the compressed header to a state before the header compression using the context.

The following three operation modes are defined in ROHC.

(1) U-Mode (Unidirectional Mode)

In the U-mode, there is no feedback information from the decompressing unit to the compressing unit. Thus, while an amount of signaling is small, a degree of reliability of communication is low.

(2) O-Mode (Bidirectional Optimistic Mode)

In the O-mode, a feedback channel from the decompressing unit to the compressing unit is used for an error recovery request and an acknowledgment of a context update.

(3) R-Mode (Bidirectional Reliable Mode)

In the R-mode, the feedback channel is used more actively than in the O-mode. That is, in the R-mode, acknowledgments of all of context updates are transmitted using the feedback channel.

As described above, the amount of feedback information is increased in order of the U-mode, the O-mode, and the R-mode, whereas the degree of reliability of communication is increased in order of the U-mode, the O-mode, and the R-mode.

In related art, switching among the above-described three operation modes is performed on the basis of a “given switching pattern” set in advance.

### PRIOR ART DOCUMENTS

### Patent Documents

[Patent Document 1] Japanese Laid-open Patent Publication No. 2010-199750

[Patent Document 2] Japanese Laid-open Patent Publication No. 2012-169764

### SUMMARY

According to an aspect of the invention, a wireless communication device includes: a memory, and a processor coupled to the memory and configured to: wirelessly receive a packet including a header that is compressed by another wireless communication device, decompress the compressed header based on a set compression mode among a plurality of compression modes, each of the plurality of compression modes having a different amount of feedback information transmitted from the wireless communication device to the another wireless communication device, obtain a quality of a wireless channel from the another wireless communication device to the wireless communication device, and select the set compression mode based on the obtained quality of the wireless channel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a wireless communication system according to a first embodiment;

FIG. 2 is a block diagram illustrating an example of a wireless communication device on a transmitting side according to the first embodiment;

FIG. 3 is a block diagram illustrating an example of a wireless communication device on a receiving side according to the first embodiment;

FIG. 4 is a flowchart illustrating an example of processing operation of a wireless communication device on a receiving side according to the first embodiment;

FIG. 5 is a diagram illustrating an example of a count table according to a second embodiment;

FIG. 6 is a diagram illustrating an example of processing operation of a wireless communication system according to the second embodiment;

FIG. 7 is a flowchart illustrating an example of processing operation of a wireless communication device on a receiving side according to the second embodiment;

FIG. 8 is a diagram illustrating an example of processing operation of a wireless communication system according to a third embodiment;

FIG. 9 is a flowchart illustrating an example of processing operation of a wireless communication device on a receiving side according to the third embodiment; and

FIG. 10 is a diagram illustrating an example of hardware configuration of a wireless communication device.

### DESCRIPTION OF EMBODIMENTS

The third generation partnership project long term evolution (3GPP LTE) standard as a wireless communication standard specifies that ROHC be applied to Layer 2 (data link layer).

However, when a mode is switched in a fixed manner according to a “given switching pattern” as in the related art, the switching of the mode may cause a mismatch between the mode and conditions of a wireless communication channel, and decrease a degree of reliability of communication. This is attributable, for example, to more violent variations in communication channel conditions in a wireless communication channel than in a wire communication channel.

The disclosed technology has been made in view of the above, and it is an object of the technology to provide a wireless communication device, a wireless communication system, and a communication control method that can reduce a decrease in a degree of reliability of communication.

Embodiments of a wireless communication device, a wireless communication system, and a communication control method disclosed in the present application will hereinafter be described in detail with reference to the drawings. It is to be noted that the wireless communication device, the wireless communication system, and the communication control method disclosed in the present application are not limited by the embodiments. In addition, constitutions having identical functions in the embodiments are identified by the same reference symbols, and repeated description thereof will be omitted.

### First Embodiment

[Outline of Wireless Communication System]

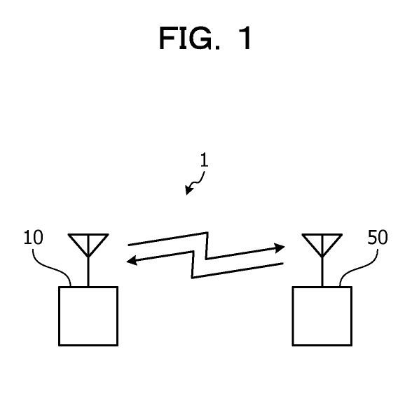

FIG. 1 is a diagram illustrating an example of a wireless communication system according to a first embodiment. In FIG. 1, the wireless communication system 1 includes a wireless communication device 10 and a wireless communication device 50. The following description will be made supposing that the wireless communication device 10 is on the “transmitting side” of a compressed packet, and that the wireless communication device 50 is on the “receiving side” of the compressed packet.

The wireless communication device 10 includes a compressing unit. The wireless communication device 10 transmits, to the wireless communication device 50, a packet compressed according to a set “usage compression mode.”

The wireless communication device 50 includes a decompressing unit. The wireless communication device 50 decompresses the received compressed packet according to the set “usage compression mode.”

In addition, the wireless communication device 50 detects “communication quality” between the wireless communication device 50 and the wireless communication device 10, and performs “switching control” that switches the “usage compression mode” among a plurality of “compression modes” on the basis of the detected “communication quality.” The “communication quality” may be detected on the basis of the number of times of retransmission, or may be detected on the basis of reception field strength, for example. The plurality of “compression modes” are different from each other in amount of feedback information from the decompressing unit to the compressing unit. That is, the plurality of “compression modes” are different from each other in degree of reliability of communication. The plurality of “compression modes” are for example the U-mode, the O-mode, and the R-mode described above. The following description will be made supposing that the three modes are used.

For example, the wireless communication device 50 associates three “communication quality ranges” of different communication quality levels with the three compression modes (the U-mode, the O-mode, and the R-mode), respectively. For example, the U-mode is associated with a “high communication quality range” of highest communication quality levels, the O-mode is associated with a “medium communication quality range” of next highest communication quality levels, and the R-mode is associated with a “low communication quality range” of lowest communication quality levels. Then, the wireless communication device 50 identifies the “communication quality range” in which the value of the detected communication quality falls, and switches the “usage compression mode” to the compression mode associated with the identified “communication quality range.” That is, the wireless communication device 50 switches the usage compression mode of the decompressing unit in the wireless communication device 50 itself, and transmits information on the switched “usage compression mode” (which information may hereinafter be referred to as a “mode notification”) to the wireless communication device 10. The usage compression mode of the compressing unit in the wireless communication device 10 is thereby switched.

Because the wireless communication device 50 performs “switching control” based on the “communication quality” as described above, switching can be performed to the compression mode corresponding to a high degree of reliability of communication when the communication quality is low. As a result, a decrease in the degree of reliability of communication can be reduced. In addition, an amount of signaling can be reduced because switching can be performed to the compression mode corresponding to a small amount of feedback information when the communication quality is high.

[Example of Configuration of Wireless Communication Device on Transmitting Side]

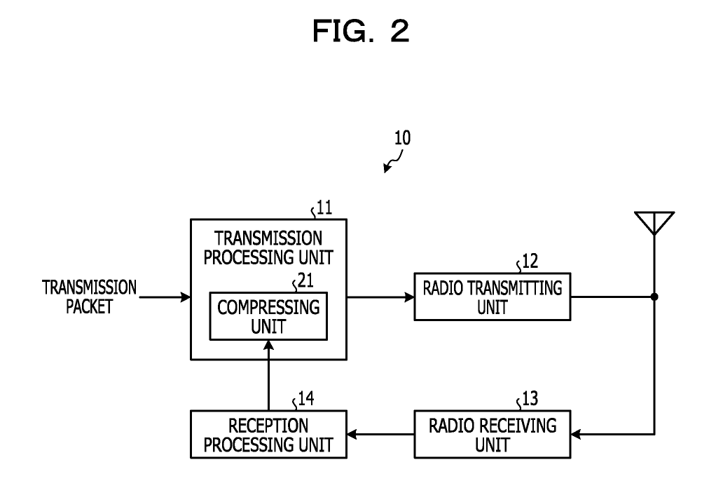

FIG. 2 is a block diagram illustrating an example of a wireless communication device on a transmitting side according to the first embodiment. In FIG. 2, the wireless communication device 10 includes a transmission processing unit 11, a wireless transmitting unit 12, a wireless receiving unit 13, and a reception processing unit 14.

The transmission processing unit 11 performs processing in Layer 2 (L2) and processing in Layer 1 (L1). Layer 2 includes for example a packet data convergence protocol (PDCP) layer, a radio link control (RLC) layer, and a medium access control (MAC) layer. The above-described ROHC layer is included in the PDCP layer.

As illustrated in FIG. 2, for example, the transmission processing unit 11 includes a compressing unit 21. The compressing unit 21 forms a compressed packet by compressing a transmission packet (that is, transmission data). This compression processing is processing in the above-described PDCP layer. In this case, the compressing unit 21 performs the packet compression processing using the “compression mode” indicated by the “mode notification” transmitted from the above-described wireless communication device 50.

In addition, the transmission processing unit 11 subjects the formed compressed packet to encoding processing and modulation processing, and outputs a resulting transmission signal to the wireless transmitting unit 12. This encoding processing and this modulation processing are processing in the above-described Layer 1.

The wireless transmitting unit 12 subjects the transmission signal received from the transmission processing unit 11 to given wireless transmission processing (for example digital-to-analog conversion, up-conversion, and the like), and transmits a resulting wireless signal to the wireless communication device 50 via an antenna.

The wireless receiving unit 13 receives a signal transmitted from the wireless communication device 50 via the antenna. Then, the wireless receiving unit 13 subjects the received signal to given wireless reception processing (for example down-conversion, analog-to-digital conversion, and the like), and outputs a resulting signal to the reception processing unit 14.

The reception processing unit 14 subjects the signal received from the wireless receiving unit 13 to given reception processing (demodulation processing, decoding processing, and the like), and extracts a “mode notification” from resulting received data. Then, the reception processing unit 14 outputs the extracted “mode notification” to the compressing unit 21.

[Example of Configuration of Wireless Communication Device on Receiving Side]

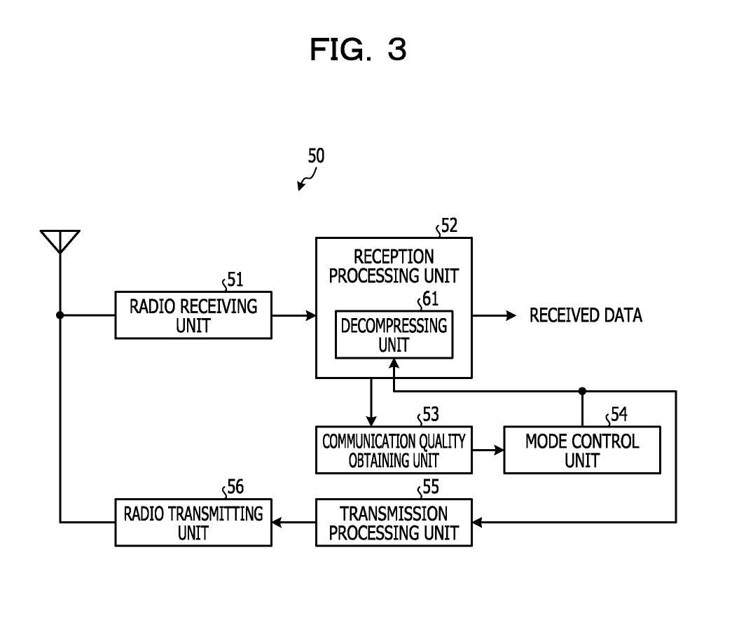

FIG. 3 is a block diagram illustrating an example of a wireless communication device on a receiving side according to the first embodiment. In FIG. 3, the wireless communication device 50 includes a wireless receiving unit 51, a reception processing unit 52, a communication quality obtaining unit 53, a mode control unit 54, a transmission processing unit 55, and a wireless transmitting unit 56.

The wireless receiving unit 51 receives a signal transmitted from the wireless communication device 10 via an antenna. Then, the wireless receiving unit 51 subjects the received signal to given wireless reception processing (down-conversion, analog-to-digital conversion, and the like), and outputs a resulting signal to the reception processing unit 52.

The reception processing unit 52 performs processing in Layer 1 (L1) and processing in Layer 2 (L2). As described above, Layer 2 includes for example the PDCP layer, the RLC layer, and the MAC layer. In addition, the above-described ROHC layer is included in the PDCP layer.

As illustrated in FIG. 3, for example, the reception processing unit 52 includes a decompressing unit 61. The reception processing unit 52 reproduces a transmission packet by decompressing the signal (that is, a compressed packet) received from the wireless receiving unit 51 in the decompressing unit 61. This decompression processing is processing in the above-described PDCP layer. In this case, the decompressing unit 61 performs the packet decompression processing using the “compression mode” indicated by the “mode notification” received from the mode control unit 54 which will be described later.

In addition, the reception processing unit 52 outputs a signal (information) used to obtain communication quality (namely, quality of wireless channel) in the communication quality obtaining unit 53 which will be described later to the communication quality obtaining unit 53. The signal (information) used to obtain communication quality may for example indicate the number of times of retransmission, or may indicate reception field strength.

The communication quality obtaining unit 53 calculates (or detects) “communication quality” between the wireless communication device 10 and the wireless communication device 50 on the basis of the signal (information) received from the reception processing unit 52. Then, the communication quality obtaining unit 53 outputs the value of the calculated (or detected) wireless quality to the mode control unit 54.

The mode control unit 54 identifies the compression mode corresponding to the value of the wireless quality which value is received from the communication quality obtaining unit 53 on the basis of the received value of the wireless quality and the above-described “correspondence relations” between the communication quality ranges and the compression modes. Then, the mode control unit 54 generates a “mode notification” including information on the identified compression mode, and outputs the generated “mode notification” to the decompressing unit 61 and the transmission processing unit 55.

The transmission processing unit 55 subjects the mode notification received from the mode control unit 54 to encoding processing and modulation processing, and outputs a resulting transmission signal to the wireless transmitting unit 56. This encoding processing and this modulation processing are processing in the above-described Layer 1.

The wireless transmitting unit 56 subjects the transmission signal received from the transmission processing unit 55 to given wireless transmission processing (for example digital-to-analog conversion, up-conversion, and the like), and transmits a resulting wireless signal to the wireless communication device 10 via the antenna.

[Example of Operation of Wireless Communication System]

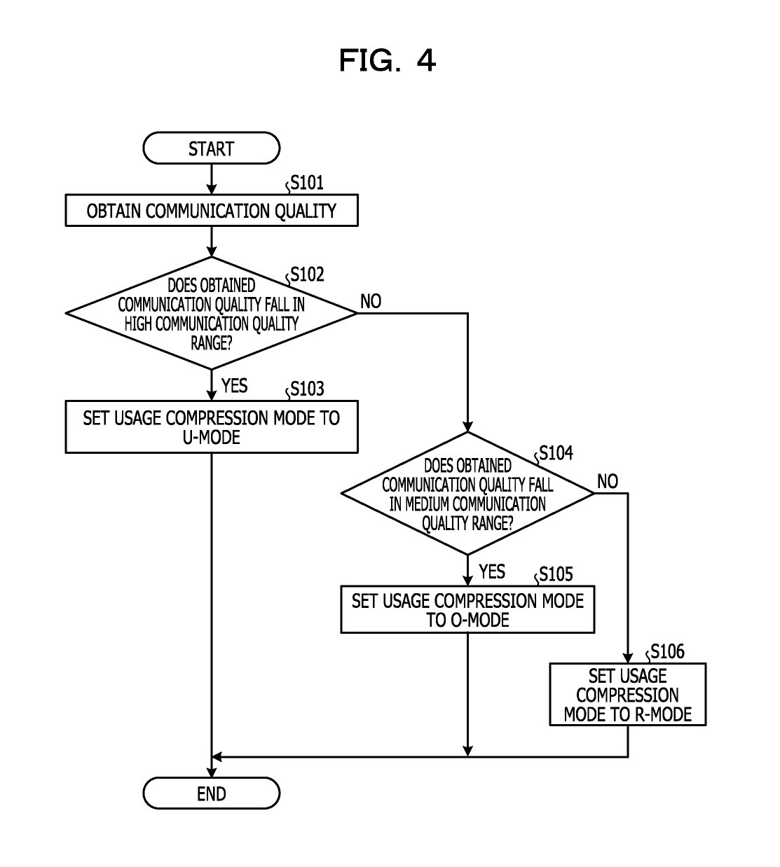

Description will be made of an example of processing operation of a wireless communication system having the above configuration. The following description will be made particularly of processing operation of a wireless communication device on a receiving side. FIG. 4 is a flowchart illustrating an example of processing operation of a wireless communication device on a receiving side according to the first embodiment. The wireless communication device 50 illustrated in FIG. 3 may perform the processing operation illustrated in FIG. 4. Incidentally, the processing operation illustrated in FIG. 4 may be performed repeatedly in given cycles.

The communication quality obtaining unit 53 obtains “communication quality” between the wireless communication device 10 and the wireless communication device 50 on the basis of a signal (information) received from the reception processing unit 52 (step S101).

The mode control unit 54 identifies the communication quality range in which the communication quality obtained in the communication quality obtaining unit 53 falls. That is, the mode control unit 54 determines whether or not the obtained communication quality falls in the high communication quality range (step S102).

When the obtained communication quality falls in the high communication quality range (affirmative in step S102), the mode control unit 54 sets the usage compression mode to the U-mode (step S103). That is, the mode control unit 54 generates a “mode notification” indicating the U-mode, and outputs the generated “mode notification” to the decompressing unit 61 and the transmission processing unit 55.

When the obtained communication quality does not fall in the high communication quality range (negative in step S102), the mode control unit 54 determines whether or not the obtained communication quality falls in the medium communication quality range (step S104).

When the obtained communication quality falls in the medium communication quality range (affirmative in step S104), the mode control unit 54 sets the usage compression mode to the O-mode (step S105).

When the obtained communication quality does not fall in the medium communication quality range (negative in step S104), the mode control unit 54 sets the usage compression mode to the R-mode (step S106).

As described above, according to the present embodiment, in the wireless communication device 50, the communication quality obtaining unit 53 detects “communication quality” between the wireless communication device 10 and the wireless communication device 50. Then, the mode control unit 54 performs switching control that switches among the plurality of compression modes corresponding to the respective different amounts of feedback information on the basis of the communication quality detected in the communication quality obtaining unit 53. For example, the mode control unit 54 switches to a compression mode corresponding to a larger amount of feedback information as the communication quality detected in the communication quality obtaining unit 53 becomes lower.

The configuration of the wireless communication device 50 can reduce a decrease in the degree of reliability of communication. In addition, an amount of signaling can be reduced because switching can be performed to the compression mode corresponding to a small amount of feedback information when the communication quality is high.

### Second Embodiment

In a second embodiment, the “number of pieces of data in each range of the number of times of retransmission” is used as an index of “communication quality.” Incidentally, main configurations of wireless communication devices in the second embodiment are the same as the main configurations of the wireless communication devices 10 and 50 in the first embodiment, and will therefore be described with reference to FIGS. 2 and 3. In addition, the wireless communication device on the transmitting side in the second embodiment is not different from the wireless communication device on the transmitting side of the first embodiment, and therefore the following description will be made mainly of the wireless communication device on the receiving side.

[Example of Configuration of Wireless Communication Device on Receiving Side]

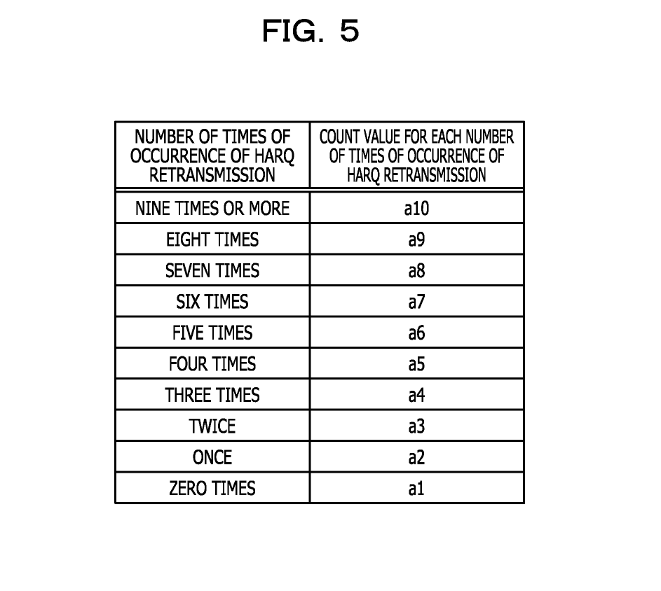

In the wireless communication device 50 according to the second embodiment, the communication quality obtaining unit 53 reads the number of times of occurrence of hybrid automatic repeat request (HARQ) retransmission of each piece of received data, and counts the number of pieces of data for each number of times of occurrence of HARQ retransmission. Then, the communication quality obtaining unit 53 outputs the counted number of pieces of data for each number of times of occurrence of HARQ retransmission to the mode control unit 54. Incidentally, the communication quality obtaining unit 53 may create a “count table” as illustrated in FIG. 5. FIG. 5 is a diagram illustrating an example of a count table according to the second embodiment.

The mode control unit 54 calculates the number of pieces of data in each “range of numbers of times of retransmission” on the basis of the number of pieces of data for each number of times of occurrence of HARQ retransmission, the number of pieces of data for each number of times of occurrence of HARQ retransmission being received from the communication quality obtaining unit 53. For example, a range of numbers of times of retransmission in which range the number of times of retransmission is less than seven (“first threshold value”) is set as a “first range of numbers of times of retransmission,” a range of numbers of times of retransmission in which range the number of times of retransmission is seven (“first threshold value”) or more is set as a “second range of numbers of times of retransmission,” a range of numbers of times of retransmission in which range the number of times of retransmission is one (“second threshold value”) or more is set as a “third range of numbers of times of retransmission,” and a range of numbers of times of retransmission in which range the number of times of retransmission is less than one, that is, no retransmission has occurred is set as a “fourth range of numbers of times of retransmission.” Then, the mode control unit 54 calculates the respective numbers of pieces of data in the “first range of numbers of times of retransmission,” the “second range of numbers of times of retransmission,” the “third range of numbers of times of retransmission,” and the “fourth range of numbers of times of retransmission.” Incidentally, suppose in the following that the number of pieces of data in the “first range of numbers of times of retransmission” is “Count A,” that the number of pieces of data in the “second range of numbers of times of retransmission” is “Count B,” that the number of pieces of data in the “third range of numbers of times of retransmission” is “Count C,” and that the number of pieces of data in the “fourth range of numbers of times of retransmission” is “Count D.” In the example of FIG. 5, Count A=a1+a2+a3+a4+a5+a6+a7. In addition, Count B=a8+a9+a10. In addition, Count C=a2+a3+a4+a5+a6+a7+a8+a9+a10. In addition, Count D=a1.

Then, the mode control unit 54 identifies a compression mode corresponding to communication quality on the basis of the respective numbers of pieces of data in the “first range of numbers of times of retransmission,” the “second range of numbers of times of retransmission,” the “third range of numbers of times of retransmission,” and the “fourth range of numbers of times of retransmission,” a “communication quality range identifying rule,” and the above-described “correspondence relations.”

The “communication quality range identifying rule” is as follows, for example.

(1) When Count D>0 and Count C=0, the communication quality range is the “high communication quality range.”

(2) When Count A<Count B, the communication quality range is the “low communication quality range.”

(3) When Count A≧Count B>0, the communication quality range is the “medium communication quality range.”

The mode control unit 54 identifies the communication quality range on the basis of the respective numbers of pieces of data in the “first range of numbers of times of retransmission,” the “second range of numbers of times of retransmission,” the “third range of numbers of times of retransmission,” and the “fourth range of numbers of times of retransmission” and the above-described “communication quality range identifying rule.” Then, the mode control unit 54 sets the compression mode corresponding to the identified communication quality range as the usage compression mode. Then, the mode control unit 54 generates a “mode notification” including information on the usage compression mode, and outputs the generated “mode notification” to the decompressing unit 61 and the transmission processing unit 55.

[Example of Operation of Wireless Communication System]

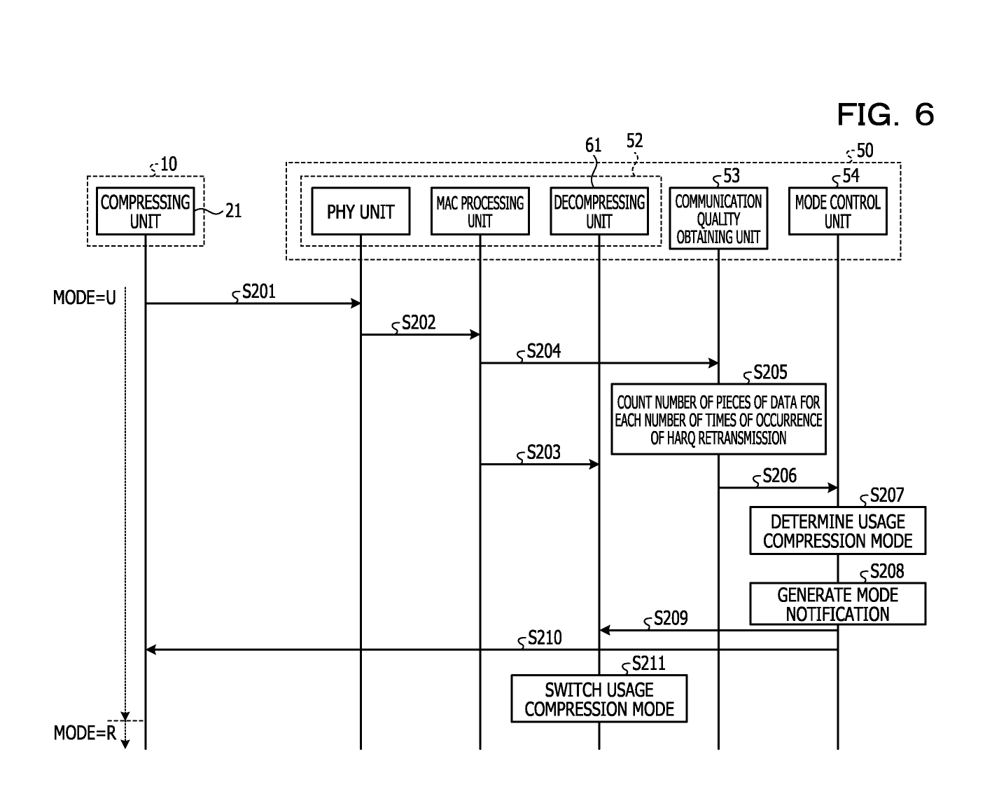

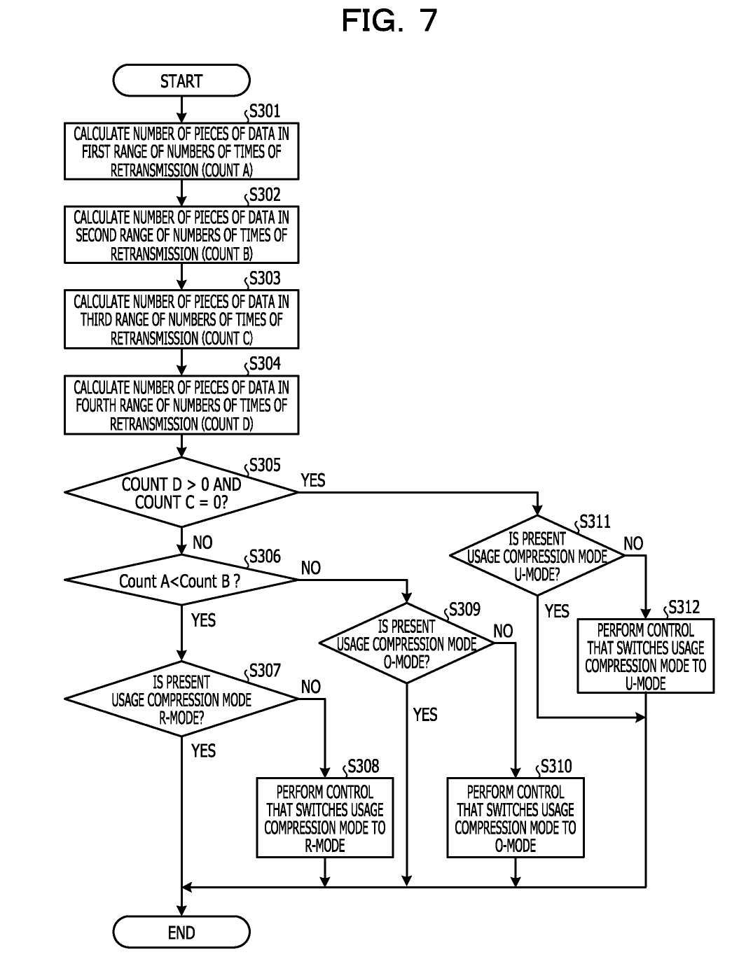

Description will be made of an example of processing operation of a wireless communication system according to the second embodiment having the above configuration. FIG. 6 is a diagram illustrating an example of processing operation of a wireless communication system according to the second embodiment. FIG. 7 is a flowchart illustrating an example of processing operation of a wireless communication device on a receiving side according to the second embodiment.

The wireless communication device 10 transmits an ROHC packet to the wireless communication device 50 (step S201). Suppose that in this stage, the usage compression mode is the U-mode.

The ROHC packet transmitted from the wireless communication device 10 is received by the reception processing unit 52 of the wireless communication device 50.

In the reception processing unit 52, the ROHC packet is input to the decompressing unit 61 via a physical layer (PHY) unit and a MAC processing unit (steps S202 and S203).

The MAC processing unit of the reception processing unit 52 outputs HARQ information to the communication quality obtaining unit 53 (step S204).

The communication quality obtaining unit 53 counts the number of pieces of data for each number of times of occurrence of HARQ retransmission (step S205). The communication quality obtaining unit 53 then outputs the counted number of pieces of data for each number of times of occurrence of HARQ retransmission to the mode control unit 54 (step S206).

The mode control unit 54 determines the usage compression mode on the basis of the number of pieces of data for each number of times of occurrence of HARQ retransmission, the number of pieces of data for each number of times of occurrence of HARQ retransmission being received from the communication quality obtaining unit 53 (step S207).

For example, as illustrated in FIG. 7, the mode control unit 54 calculates the respective numbers of pieces of data in the “first range of numbers of times of retransmission,” the “second range of numbers of times of retransmission,” the “third range of numbers of times of retransmission,” and the “fourth range of numbers of times of retransmission” on the basis of the number of pieces of data for each number of times of occurrence of HARQ retransmission, the number of pieces of data for each number of times of occurrence of HARQ retransmission being received from the communication quality obtaining unit 53 (steps S301, S302, S303, and S304). The mode control unit 54 then determines whether or not “Count D>0 and Count C=0” is satisfied (steps S305 and S207).

When “Count D>0 and Count C=0” is not satisfied (negative in step S305), the mode control unit 54 determines whether or not “Count A<Count B” is satisfied (steps S306 and S207).

When “Count A<Count B” is satisfied (affirmative in step S306), the communication quality range is the “low communication quality range.” The mode control unit 54 can therefore determine that the usage compression mode may be switched to the R-mode. Then, the mode control unit 54 determines whether or not the present usage compression mode is the R-mode (step S307). When the present usage compression mode is not the R-mode (negative in step S307), the mode control unit 54 performs control that switches the usage compression mode to the R-mode (step S308). That is, the mode control unit 54 generates a mode notification indicating the R-mode (step S208), and sends out the generated mode notification to the decompressing unit 61 and the wireless communication device 10 (steps S209 and S210). Then, the decompressing unit 61 switches the usage compression mode to the R-mode (step S211). The compressing unit 21 of the wireless communication device 10 similarly switches the usage compression mode to the R-mode.

When “Count A<Count B” is not satisfied (negative in step S306), the communication quality range is the “medium communication quality range.” The mode control unit 54 can therefore determine that the usage compression mode may be switched to the O-mode. The mode control unit 54 then determines whether or not the present usage compression mode is the O-mode (step S309). When the present usage compression mode is not the O-mode (negative in step S309), the mode control unit 54 performs control that switches the usage compression mode to the O-mode (step S310). That is, the mode control unit 54 generates a mode notification indicating the O-mode (step S208), and sends out the generated mode notification to the decompressing unit 61 and the wireless communication device 10 (steps S209 and S210). The decompressing unit 61 then switches the usage compression mode to the O-mode (step S211). The compressing unit 21 of the wireless communication device 10 similarly switches the usage compression mode to the O-mode.

When “Count D>0 and Count C=0” is satisfied (affirmative in step S305), the communication quality range is the “high communication quality range.” The mode control unit 54 can therefore determine that the usage compression mode may be switched to the U-mode. Then, the mode control unit 54 determines whether or not the present usage compression mode is the U-mode (step S311). When the present usage compression mode is not the U-mode (negative in step S311), the mode control unit 54 performs control that switches the usage compression mode to the U-mode (step S312). That is, the mode control unit 54 generates a mode notification indicating the U-mode (step S208), and sends out the generated mode notification to the decompressing unit 61 and the wireless communication device 10 (steps S209 and S210). Then, the decompressing unit 61 switches the usage compression mode to the U-mode (step S211). The compressing unit 21 of the wireless communication device 10 similarly switches the usage compression mode to the U-mode. Incidentally, when the present usage compression mode is the R-mode (affirmative in step S307), when the present usage compression mode is the O-mode (affirmative in step S309), and when the present usage compression mode is the U-mode (affirmative in step S311), the processing flow of FIG. 7 is ended.

As described above, according to the present embodiment, in the wireless communication device 50, the mode control unit 54 performs switching control that switches among the plurality of compression modes corresponding to the respective different amounts of feedback information on the basis of “communication quality.” The mode control unit 54 uses the “number of pieces of data for each range of numbers of times of retransmission” as an index of “communication quality.”

The configuration of such a wireless communication device 50 can also provide effects similar to the effects of the first embodiment.

### Third Embodiment

In a third embodiment, “reception field strength” is used as an index of “communication quality.” Incidentally, main configurations of wireless communication devices according to the third embodiment are the same as the main configurations of the wireless communication devices 10 and 50 according to the first embodiment, and will therefore be described with reference to FIGS. 2 and 3. In addition, the wireless communication device on the transmitting side according to the third embodiment is not different from the wireless communication device on the transmitting side of the first embodiment, and therefore the following description will be made mainly of the wireless communication device on the receiving side.

[Example of Configuration of Wireless Communication Device on Receiving Side]

In the wireless communication device 50 according to the third embodiment, the communication quality obtaining unit 53 detects (or measures) reception field strength. The communication quality obtaining unit 53 then outputs the value of the measured reception field strength to the mode control unit 54.

The mode control unit 54 identifies a compression mode corresponding to the value of the reception field strength which value is received from the communication quality obtaining unit 53 on the basis of the received value of the reception field strength and “correspondence relations” between reception field strength ranges (corresponding to the above-described communication quality ranges) and the compression modes. In the “correspondence relations,” the U-mode is associated with a “high strength range” of highest reception field strength levels, the O-mode is associated with a “medium strength range” of next highest reception field strength levels, and the R-mode is associated with a “low strength range” of lowest reception field strength levels.

Then, the mode control unit 54 generates a “mode notification” including information on the identified compression mode, and outputs the generated “mode notification” to the decompressing unit 61 and the transmission processing unit 55.

[Example of Operation of Wireless Communication System]

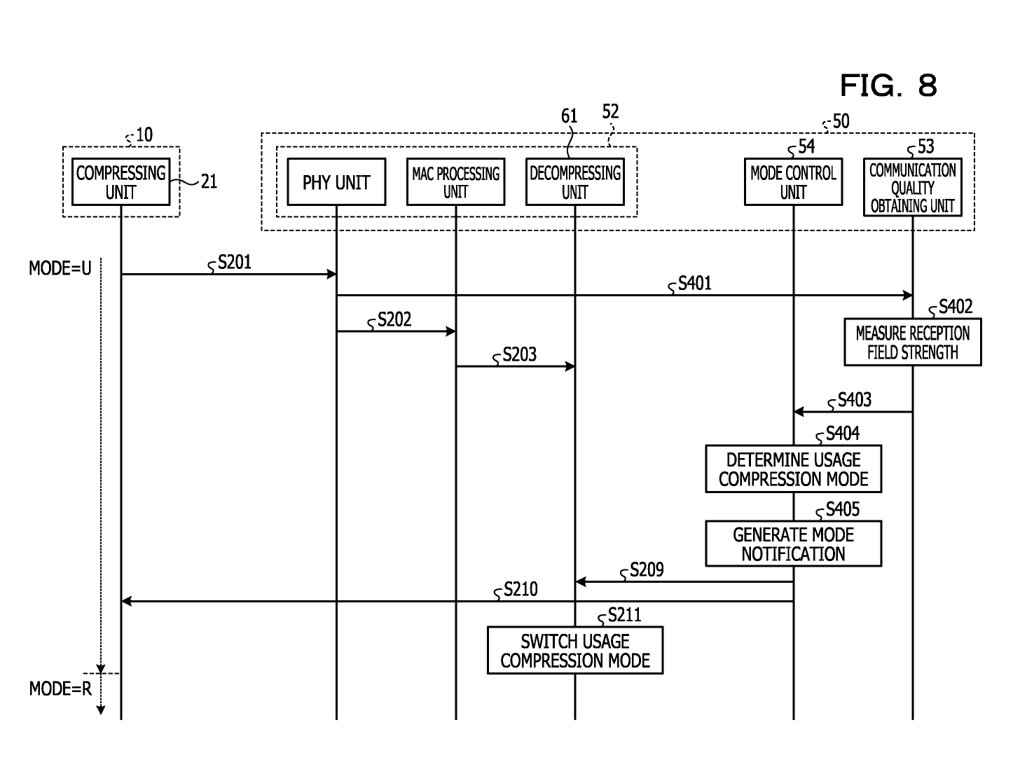

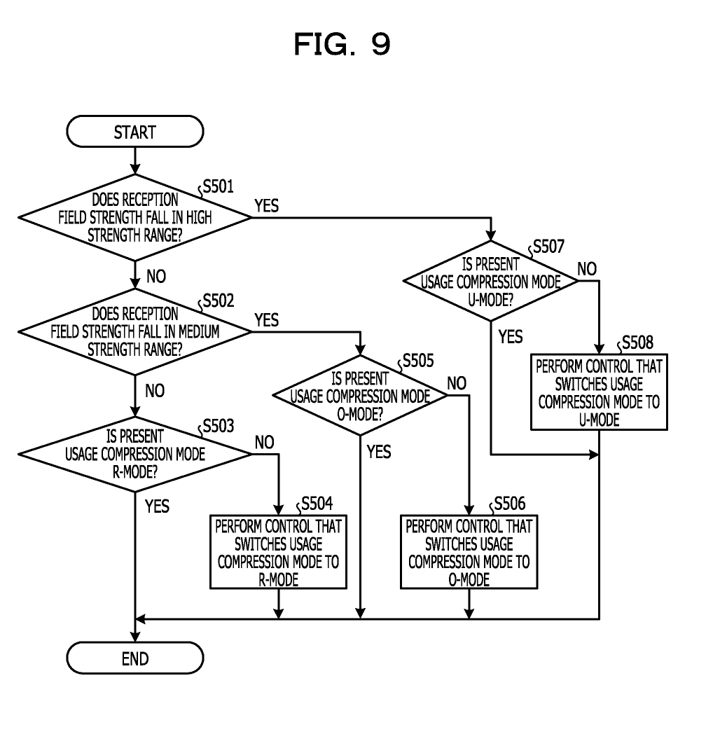

Description will be made of an example of processing operation of a wireless communication system according to the third embodiment having the above configuration. FIG. 8 is a diagram illustrating an example of processing operation of a wireless communication system according to the third embodiment. FIG. 9 is a flowchart illustrating an example of processing operation of a wireless communication device on a receiving side according to the third embodiment.

A PHY unit of the reception processing unit 52 outputs information on reception field strength to the communication quality obtaining unit 53 (step S401).

The communication quality obtaining unit 53 measures the reception field strength on the basis of the information on the reception field strength (step S402). Then, the communication quality obtaining unit 53 outputs the value of the measured reception field strength to the mode control unit 54 (step S403).

The mode control unit 54 determines a usage compression mode on the basis of the value of the reception field strength which value is received from the communication quality obtaining unit 53 (step S404).

For example, as illustrated in FIG. 9, the mode control unit 54 determines in which of the “high strength range,” the “medium strength range,” and the “low strength range” the value of the reception field strength which value is received from the communication quality obtaining unit 53 falls (steps S501 and S502).

When the value of the reception field strength falls in the “low strength range” (negative in step S501 and negative in step S502), the mode control unit 54 can determine that the usage compression mode may be switched to the R-mode. Then, the mode control unit 54 determines whether or not the present usage compression mode is the R-mode (step S503). When the present usage compression mode is not the R-mode (negative in step S503), the mode control unit 54 performs control that switches the usage compression mode to the R-mode (step S504). That is, the mode control unit 54 generates a mode notification indicating the R-mode (step S405), and sends out the generated mode notification to the decompressing unit 61 and the wireless communication device 10 (steps S209 and S210). Then, the decompressing unit 61 switches the usage compression mode to the R-mode (step S211). The compressing unit 21 of the wireless communication device 10 similarly switches the usage compression mode to the R-mode.

When the value of the reception field strength falls in the “medium strength range” (negative in step S501 and affirmative in step S502), the mode control unit 54 can determine that the usage compression mode may be switched to the O-mode. Then, the mode control unit 54 determines whether or not the present usage compression mode is the O-mode (step S505). When the present usage compression mode is not the O-mode (negative in step S505), the mode control unit 54 performs control that switches the usage compression mode to the O-mode (step S506). That is, the mode control unit 54 generates a mode notification indicating the O-mode (step S405), and sends out the generated mode notification to the decompressing unit 61 and the wireless communication device 10 (steps S209 and S210). Then, the decompressing unit 61 switches the usage compression mode to the O-mode (step S211). The compressing unit 21 of the wireless communication device 10 similarly switches the usage compression mode to the O-mode.

When the value of the reception field strength falls in the “high strength range” (affirmative in step S501), the mode control unit 54 can determine that the usage compression mode may be switched to the U-mode. Then, the mode control unit 54 determines whether or not the present usage compression mode is the U-mode (step S507). When the present usage compression mode is not the U-mode (negative in step S507), the mode control unit 54 performs control that switches the usage compression mode to the U-mode (step S508). That is, the mode control unit 54 generates a mode notification indicating the U-mode (step S405), and sends out the generated mode notification to the decompressing unit 61 and the wireless communication device 10 (steps S209 and S210). Then, the decompressing unit 61 switches the usage compression mode to the U-mode (step S211). The compressing unit 21 of the wireless communication device 10 similarly switches the usage compression mode to the U-mode. Incidentally, when the present usage compression mode is the R-mode (affirmative in step S503), when the present usage compression mode is the O-mode (affirmative in step S505), and when the present usage compression mode is the U-mode (affirmative in step S507), the processing flow of FIG. 9 is ended.

As described above, according to the present embodiment, in the wireless communication device 50, the mode control unit 54 performs switching control that switches among the plurality of compression modes corresponding to the respective different amounts of feedback information on the basis of “communication quality.” The mode control unit 54 uses “reception field strength” as an index of “communication quality.”

The configuration of such a wireless communication device 50 can also provide effects similar to the effects of the first embodiment.

### Other Embodiments

The constituent elements of the units illustrated in the first to third embodiments do not necessarily need to be physically configured as illustrated in FIGS. 1 to 9. That is, specific forms of distribution and integration of the units are not limited to the forms illustrated in FIGS. 1 to 9, but the whole or a part of the units can be configured to be distributed or integrated functionally or physically in arbitrary units according to various kinds of loads, usage conditions, and the like.

Further, the whole or an arbitrary part of various kinds of processing functions performed in the respective devices may be performed on a central processing unit (CPU) (or a microcomputer such as a micro processing unit (MPU) or a micro controller unit (MCU)). In addition, the whole or an arbitrary part of the various kinds of processing functions may be performed on a program analyzed and executed by the CPU (or the microcomputer such as the MPU or the MCU), or performed on hardware by wired logic.

The wireless communication devices according to the first to third embodiments can be realized by the following hardware configuration, for example.

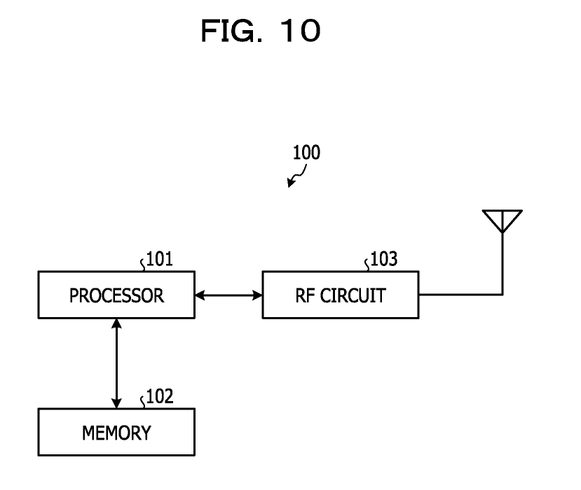

FIG. 10 is a diagram illustrating an example of hardware configuration of a wireless communication device. As illustrated in FIG. 10, the wireless communication device 100 includes a processor 101, a memory 102, and a radio frequency (RF) circuit 103. Each of the wireless communication devices 10 and 50 according to the first to third embodiments has the hardware configuration illustrated in FIG. 10. A CPU, a digital signal processor (DSP), a field programmable gate array (FPGA), or the like is cited as an example of the processor 101. In addition, a random access memory (RAM) such as a synchronous dynamic random access memory (SDRAM), a read only memory (ROM), a flash memory, or the like is cited as an example of the memory 102.

Then, the various kinds of processing functions performed in the wireless communication devices according to the first to third embodiments may be implemented by executing, by a processor, programs stored in various kinds of memory such as a nonvolatile storage medium. That is, programs corresponding to respective pieces of processing performed by the transmission processing unit 11 and the reception processing unit 14 may be recorded in the memory 102, and each program may be executed by the processor 101. In addition, the wireless transmitting unit 12 and the wireless receiving unit 13 are realized by the RF circuit 103. In addition, programs corresponding to respective pieces of processing performed by the reception processing unit 52, the communication quality obtaining unit 53, the mode control unit 54, and the transmission processing unit 55 may be recorded in the memory 102, and each program may be executed by the processor 101. In addition, the wireless receiving unit 51 and the wireless transmitting unit 56 are realized by the RF circuit 103.

Incidentally, it is assumed in this case that the various kinds of processing functions performed in the wireless communication devices according to the first to third embodiments are performed by one processor 101. However, the various kinds of processing functions performed in the wireless communication devices according to the first to third embodiments are not limited to this, but may be performed by a plurality of processors.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device comprising:
a memory; and
a processor coupled to the memory and configured to:
wirelessly receive a packet including a header that is compressed by another wireless communication device,
decompress the compressed header based on a set compression mode among a plurality of compression modes, each of the plurality of compression modes having a different amount of feedback information transmitted from the wireless communication device to the another wireless communication device,
obtain a quality of a wireless channel from the another wireless communication device to the wireless communication device, and
select the set compression mode based on the obtained quality of the wireless channel.

2. The wireless communication device according to claim 1,
wherein the processor is configured to select the set compression mode having a larger amount of feedback information as the obtained channel quality is lower.

3. The wireless communication device according to claim 1,
the quality of the wireless channel is obtained based on the number of retransmission via the wireless channel from the another wireless communication device to the wireless communication device.

4. The wireless communication device according to claim 1,
the quality of the wireless channel is obtained based on a reception field strength of the wireless channel from the another wireless communication device to the wireless communication device.

5. A wireless communication system comprising:
a first wireless communication device; and
a second wireless communication device configured to:
wirelessly receive a packet including a header that is compressed by the first wireless communication device,
decompress the compressed header based on a set compression mode among a plurality of compression modes, each of the plurality of compression modes having a different amount of feedback information transmitted from the second wireless communication device to the first wireless communication device,
obtain a quality of a wireless channel from the first wireless communication device to the second wireless communication device, and
select the set compression mode based on the obtained quality of the wireless channel.

6. The wireless communication system according to claim 5,
wherein the second wireless communication device is configured to select the set compression mode having a larger amount of feedback information as the obtained channel quality is lower.

7. The wireless communication system according to claim 5,
the quality of the wireless channel is obtained based on the number of retransmission via the wireless channel from the first wireless communication device to the second wireless communication device.

8. The wireless communication system according to claim 5,
the quality of the wireless channel is obtained based on a reception field strength of the wireless channel from the first wireless communication device to the second wireless communication device.

9. A communication control method of a wireless communication device, the communication control method comprising:
wirelessly receiving a packet including a header that is compressed by another wireless communication device;
decompressing the compressed header based on a set compression mode among a plurality of compression modes, each of the plurality of compression modes having a different amount of feedback information transmitted from the wireless communication device to the another wireless communication device;
obtaining a quality of a wireless channel from the another wireless communication device to the wireless communication device; and
selecting the set compression mode based on the obtained quality of the wireless channel.

10. The communication control method according to claim 9,
wherein the wireless communication device is configured to select the set compression mode having a larger amount of feedback information as the obtained channel quality is lower.

11. The communication control method according to claim 9,
the quality of the wireless channel is obtained based on the number of retransmission via the wireless channel from the another wireless communication device to the wireless communication device.

12. The communication control method according to claim 9,
the quality of the wireless channel is obtained based on a reception field strength of the wireless channel from the another wireless communication device to the wireless communication device.
